(19) United States
(12) Patent Application Publication
(10) Pub. No.: US 2004/0208590 A1
(43) Pub. Date: Oct. 21, 2004

(54) Fiber-optic interconnect arrangement for providing lightning-protection coupling of baseband processor to radio frequency transceiver

(75) Inventors: David H. Nabors, Huntsville, AL (US); David P. Nelson, Huntsville, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ADTRAN, INC., HUNTSVILLE, AL

(21) Appl. No.: 10/193,815

(22) Filed: Jul. 12, 2002

(51) Int. Cl. H04B 10/00

(52) U.S. Cl. 398/115

(57) ABSTRACT

The potential threat to digital radio baseband equipment from excessive currents in an electrical communication cable, due to a lightning strike at or near the top of an RF transceiver tower is avoided by replacing the electrical cable with a non-electrical signaling path, in particular a fiber optic signaling path. Power for the RF transceiver is conveyed to the tower in a separate electrical link. This serves to effectively electrically isolate baseband equipment from a potential source of potential lightning strikes, while at the same time providing full intra-communication connectivity within the digital radio.

### FIELD OF THE INVENTION

The present invention relates in general to communication systems and components therefor, and is particularly directed to a non-electrical (optical fiber-based), interconnect arrangement for coupling a baseband processor to an elevated platform (e.g., tower)-mounted RF transceiver, such as one employed for wireless digital telecommunications. Replacing the electrical link (coaxial cable) between the baseband processor and the RF transceiver with optical fiber serves to protect the baseband equipment from lightning-induced currents that are capable of propagating down an electrical conductor, such as, a coaxial cable, that has been conventionally employed to interconnect the baseband equipment with the RF transceiver and antenna components atop the elevated platform.

### BACKGROUND OF THE INVENTION

Although legacy (copper) wirelines have served as a principal information transport backbone for a variety of telecommunication networks, the continued development of other signal transport technologies, particularly those capable of relatively wideband service, including wireless (e.g., radio) networks, have resulted in a multiplicity of systems that serve a diversity of environments and users. A particular advantage of wireless service is the fact that it is very flexible and not limited to serving only customers having access to existing or readily installable copper cable plants. Moreover, there are many environments, such as, but not limited to portable data terminal equipments (DTEs), where a digital wireless subsystem may be the only practical means of communication.

In order to provide digital communication service, the wireless digital radio is typically configured as diagrammatically illustrated in FIG. 1 to include a baseband processor subsystem 10 and an RF transceiver subsystem (RF converter) 20. The baseband digital (processor) subsystem 10 is customarily installed at a relatively accessible ground station location (e.g., within a building), so that it may be interfaced via an existing digital network's infrastructure (such as a plurality of T1 links) to an incumbent service provider site. The RF transceiver subsystem 20 is usually mounted on an elevated platform, such as adjacent to an antenna 25 to which it is coupled via a diplexer 22, at or near the top of a radio tower.

Power and signaling are normally coupled between the baseband equipment site 10 and the tower-mounted RF transceiver 20 by means of one or more sections of electrical cable plant (including coaxial cable) 30. Unfortunately, this cable plant provides a path for lightning-induced currents (as may strike the antenna) that can damage the cable itself, as well as the baseband processor and associated interface and other equipment at or near the base of the radio tower.

### SUMMARY OF THE INVENTION

In accordance with the present invention, this potential threat to the baseband equipment installation from lightning-induced currents flowing through the coaxial cable, as a result of a lightning strike at or near the top of the tower (e.g., at the antenna), is effectively circumvented by replacing the electrical cable used for signaling between the baseband processor (located at or near the base of the tower) and the RF transceiver (mounted at the top of the tower) with a non-electrical signaling path. In a preferred embodiment, the replacement signaling path comprises a fiber optic signaling path, which is interfaced with the baseband processor and the RF transceiver by associated electro-optic and opto-electronic converter units. In addition to communication signals, the fiber optic path also carries a full duplex control channel.

The electro-optic and opto-electronic converter unit through which the baseband processor is coupled to the fiber optic signaling path includes a pair of quadrature (I/Q) modulation transmit channels that would normally be modulated on an intermediate frequency RF carrier and coupled to the RF transceiver via a coaxial cable. These channels are coupled through low pass filters to respective electro-optic (E-O) converters, which convert the communication channel signals into optical signals for application to a first pair of uplink (transmit direction from the baseband processor to the RF transceiver) optical fibers. At their RF transceiver-associated ends, the uplink optical fibers are coupled to respective opto-electronic converters, outputs of which are coupled to the RF transceiver's RF transmitter. In order to accommodate an uplink control channel, one of the uplink channel fibers is used for baseband processor-to-RF transceiver messages. The uplink control channel may comprise a frequency shift keyed (FSK) modulation channel supplied by an FSK modulator.

In the receive direction, a second pair of downlink (from the RF transceiver to the baseband processor) optical fibers is used to transport optical signals modulated with respective quadrature (I/Q) modulation receive channels sourced from the RF transceiver's receiver section. Also, FSK encoded control channel information is transported over one of the downlink fibers. To extract the control channel, the received communication channel path is coupled to an FSK demodulator, the output of which is supplied to the baseband processor.

### BRIEF DESCRIPTION OF THE DRAWINGS

FIG. 1 diagrammatically illustrates a conventional tower-installed RF transceiver coupled via a coaxial cable to a baseband processor subsystem;

FIG. 2 diagrammatically illustrates an optical fiber-based interconnect arrangement for coupling a baseband processor with an elevated platform-mounted RF transceiver according to the present invention;

FIG. 3 shows an implementation of the electro-optic and opto-electronic converter unit through which the baseband processor is coupled to the uplink fiber optic signaling path of the arrangement of FIG. 3; and

FIG. 4 shows an implementation of the electro-optic and opto-electronic converter unit through which the RF transceiver is coupled to the downlink fiber optic signaling path of the arrangement of FIG. 3.

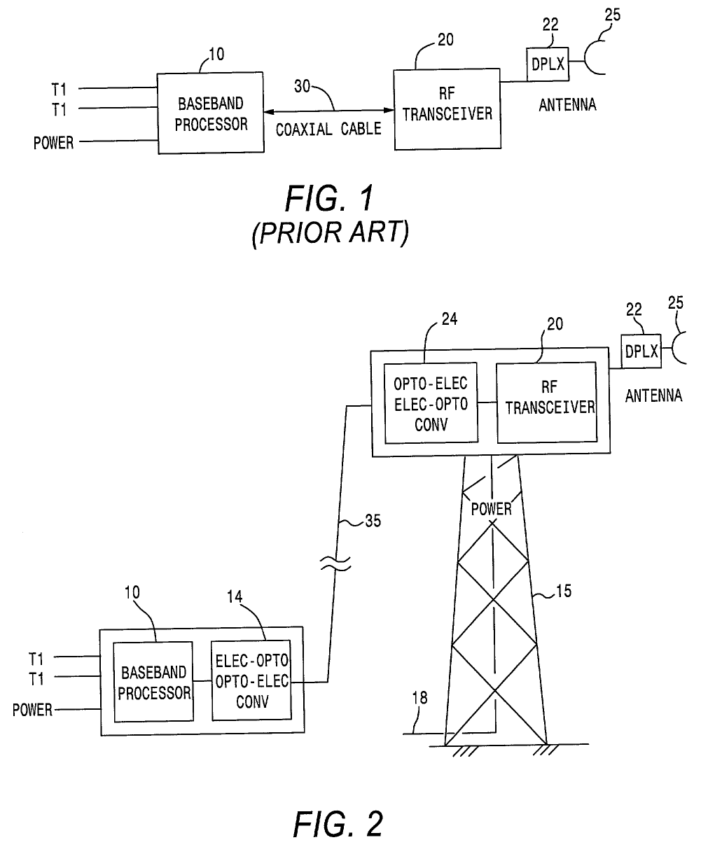

### DETAILED DESCRIPTION

Before describing in detail the new and improved optical fiber-based, baseband processor to RF transceiver interconnect arrangement of the present invention, it should be observed that the invention resides primarily in modular arrangements of conventional RF transceiver components, digital communication circuits, power supply and optical fiber components. In terms of a practical implementation that facilitates their manufacture and installation at a communication site having access to an existing digital signal-transporting wireline cable plant, these modular arrangements may be readily configured using field programmable gate array (FPGA) and application specific integrated circuit (ASIC) chip sets, and commercially available electro-optic and opto-electronic devices and components. As a consequence, the configurations of these arrangements and the manner in which they may be interfaced with an existing digital signal (T1) wireline link or other terrestrial digital telecommunication loop have been illustrated in readily understandable block diagram format, which shows only those specific details that are pertinent to the present invention, so as not to obscure the disclosure with details that are readily apparent to one skilled in the art having the benefit of present description.

As pointed out briefly above, to avoid the potential threat to baseband equipment from damaging lightning-induced currents in coaxial cable used to interconnect baseband equipment with the RF transceiver at the top of an elevated platform, the invention replaces the electrical (coaxial) cable with a non-electrical signaling path. In a preferred embodiment, shown diagrammatically in FIG. 2, the replacement signaling path comprises a fiber optic signaling path 35, which is interfaced with baseband processor 10 (which may be located in the vicinity of the base of a radio tower 15) and RF transceiver 20 by associated electro-optic and opto-electronic converter units 14 and 24, respectively. In addition to the communication signals, the fiber optic path 35 also carries a full duplex control channel. With the elimination of the coaxial cable, power for the RF transceiver is carried by an electrical cable from separate power supply equipment.

The RF transceiver 20 may comprise an ISM-band compatible (e.g., spread spectrum) digital transceiver. In the transmit direction, RF transceiver 20 performs modulation and up-conversion of baseband communication signals that are uplinked from the baseband processor 10 to an FCC-conformal band RF signal (e.g., a 2-6 GHz spread spectrum signal), for application via a diplexer 22 to radio antenna 25. In the receive direction, the RF transceiver is operative to down-convert and demodulate RF communication signals received by the antenna 25 and coupled therefrom by the diplexer 22 to baseband for downlink transport to the baseband processor 10.

The respective transmit and receive frequencies interfaced by the diplexer 22 with antenna 25 are defined in accordance with one of two complementary frequency plans, the other of which is employed by a companion radio at a remote site. To facilitate selection of either frequency plan, the RF transceiver-diplexer arrangement may be configured in the manner described in the U.S. Patent to P. Nelson et al, U.S. Pat. No. 6,178,312, issued Jan. 23, 2001, entitled: “Mechanism for Automatically Tuning Transceiver Frequency Synthesizer to Frequency of Transmit/Receiver Filter” (hereinafter referred to as the '312 Patent), assigned to the assignee of the present application and the disclosure of which is incorporated herein.

Power for operating both the baseband processor 10 and the RF transceiver may be extracted from a terrestrial wireline via a line interface, that is coupled to tip and ring portions of respective transmit and receive segments of a powered T1 wireline link, such as that described in co-pending U.S. patent application, Ser. No. 09/771,370, filed Jan. 25, 2001, by Eric Rives et al, entitled: “Loop-Powered T1 Radio” (hereinafter referred to as the '370 application), assigned to the assignee of the present application and the disclosure of which is incorporated herein. As described in the '370 application, deriving power from the wireline/span effectively eliminates having to locate the RF transceiver where a separate dedicated power supply is either available or can be installed. The voltages extracted from the span are scaled to appropriate DC voltages for powering the digital signaling and transceiver electronics of the radio. As pointed out above, power for the RF transceiver is carried by an electrical cable 18 that is remote/separate from the signaling optical fiber and linked to power supply equipment apart from the baseband processor. Where both units 10 and 20 are line powered, their respective units are isolated at the base of the tower.

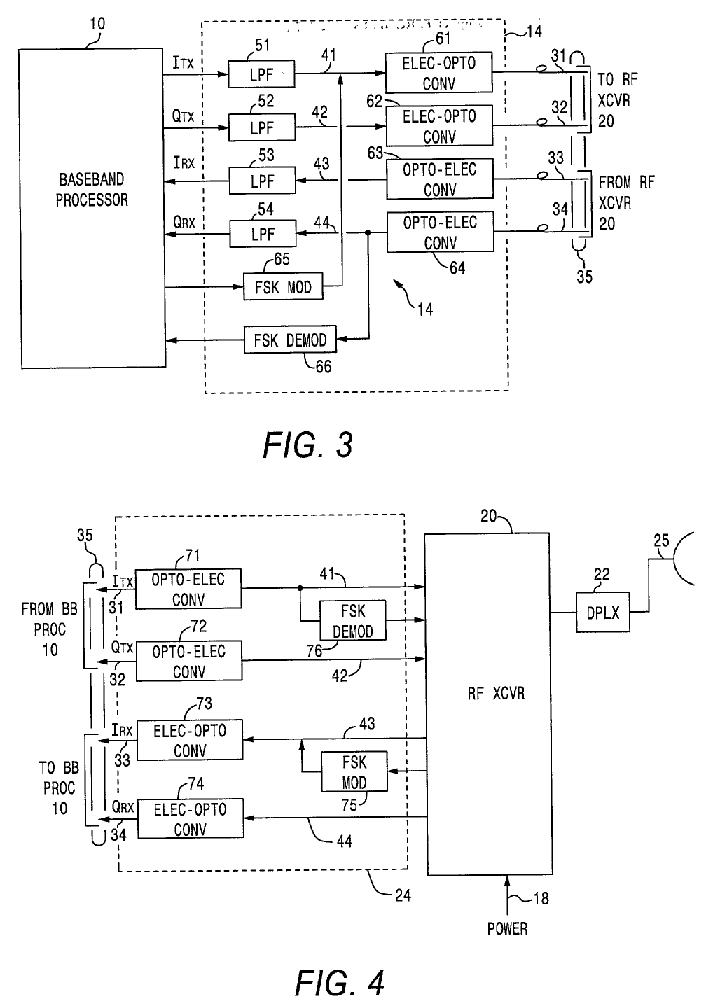

Attention is now directed to FIG. 3, which shows a non-limiting embodiment of an implementation of the electro-optic and opto-electronic converter unit 14 through which the baseband processor 10 is coupled to the fiber optic signaling path 35. In the transmit or uplink direction to the RF transceiver, a pair of quadrature (I/Q) modulation transmit channels 41 and 42 that would normally be directly coupled via a coaxial cable to the RF transceiver are coupled through low pass filters 51 and 52 to respective electro-optic (E-O) converters 61 and 62. E-O converters 61 and 62 have their outputs coupled to optical fiber terminations (not shown), and are operative to convert the communication channel signals into optical signals for application to respective optical fibers 31 and 32 of a set of four optical fibers used to provide full duplex communication and control signal transport between the baseband processor and the RF transceiver.

At their far (RF transceiver-associated) ends, optical fibers 31 and 32 are coupled to respective opto-electronic converters, as will be described with reference to FIG. 4. The choice in the number of optical fibers employed depends upon design considerations and cost. Because single wavelength fiber couplers are less expensive than multi-wavelength couplers, and the fibers themselves are relatively inexpensive, in the present embodiment, each (I/Q uplink and downlink) channel has its own dedicated fiber.

To accommodate the control channel, one of the transmit channels (e.g., the in-phase (I) uplink communication channel 41 in the present embodiment) and its associated fiber 31 are used for transporting control channel information from the baseband processor to the RF transceiver, and one of the receive channels (e.g., the in-phase (I) communication channel 43) and its associated downlink fiber 33 is used for transporting control channel information from the RF transceiver to the baseband processor. As noted above, the control channel may comprise a frequency shift keyed (FSK) modulation channel supplied by an FSK modulator 65 and having a center frequency on the order of 1625 Hz (+/−425 Hz), which is injected into the transmit path via a summing unit 55 coupled to the output of the low pass filter 51.

In a complementary manner, in the downlink direction (from the RF transceiver), a pair of downlink optical fibers 33 and 34 are coupled to respective opto-electronic (O-E) converters 63 and 64. The downlink fibers 33 and 34 are used to transport a pair of optical signals modulated with respective quadrature (I/Q) modulation receive channels as produced by the RF transceiver 20. O-E converters 63 and 64 output the receive communication channel signals 43 and 44, which are then filtered by low pass filters 53 and 54 and supplied to the baseband processor 10. As described above, control channel information may be transported over the in-phase (I) receive communication channel 43 from the RF transceiver 20. To extract the control channel, the received communication channel path 43 is coupled to an FSK demodulator 66 prior to the low pass filter 53, the output of FSK demodulator being supplied to the baseband processor.

A non-limiting embodiment of an implementation of the electro-optic and opto-electronic converter unit 24 through which the RF transceiver 20 is coupled to the fiber optic signaling path 35 is shown in FIG. 4. In the receive direction (from the RF transceiver 20), the uplink optical fibers 31 and 32, which transport optical signals modulated with respective quadrature (I/Q) modulation receive channels as sourced from the baseband processor 10, are coupled to respective O-E converters 71 and 72. O-E converters 71 and 72 output the transmit communication channel signals 41 and 42 for application to the RF transceiver 20 for transmission. In addition, control channel information transported over the in-phase (I) receive communication channel 41 is extracted via an FSK demodulator 76 for application to the RF transceiver's internal registers that set its operational parameters.

In the downlink direction toward the baseband processor 10, quadrature (I/Q) modulation receive channels 43 and 44 are coupled to respective electro-optic (E-O) converters 73 and 74. E-O converters 73 and 74 are respectively coupled to the downlink optical fibers 33 and 34 and are operative to convert the receive communication channel signals output by the RF transceiver into optical signals for application to fibers 33 and 34, for transport to the baseband processor 10. At their far ends, downlink optical fibers 33 and 34 are coupled to the respective O-E converters 63 and 64 associated with the I/Q receive channels of the baseband processor, described above. To accommodate the control channel, in-phase (I) communication channel 43 is used for transporting control channel information from the RF transceiver to the baseband processor, as described above. For this purpose, the control channel comprises an FSK modulation channel supplied by an FSK modulator 75 injected into the receive path 43.

As will be appreciated from the foregoing description, the potential threat to digital radio baseband equipment from excessive currents that may flow through an electrical communication cable, as a result of a lightning strike at or near the top of the RF transceiver tower, is effectively circumvented in accordance with the present invention by replacing the electrical (coaxial) cable with a non-electrical signaling path, such as a fiber optic signaling path. In addition, power for the RF transceiver is conveyed to the tower in a separate electrical link. This serves to effectively electrically isolate baseband equipment from potential lightning strikes, while at the same time providing full intra-communication connectivity within the digital radio.

While we have shown and described an embodiment in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

What is claimed

1. A communication architecture comprising:
a radio frequency (RF) transceiver installable at an elevated platform that is subject to a lightning strike;
a digital communication signal processing unit baseband processor installable at a location separate from said elevated platform, and being operative to interface communication signals with said RF transceiver; and
a non-electrical signaling path coupling said RF transceiver with said baseband processor, and being operative to transport communication signals from said baseband processor to said RF transceiver for transmission thereby, and being operative to transport communication signals received by said RF transceiver to said baseband processor.

2. The communication architecture according to claim 1, wherein said digital communication signal processing unit comprises a baseband processor that is operative to interface digital telecommunication signals transported over a terrestrial digital telecommunication link with said non-electrical signaling path.

3. The communication architecture according to claim 1, wherein power for operating said RF transceiver is conveyed from a power source to said RF transceiver over an electrical link separate from said non-electrical signaling path coupling said RF transceiver with said digital communication signal processing unit.

4. The communication architecture according to claim 1, wherein said non-electrical signaling path is operative to transport a control channel between said digital communication signal processing unit and said RF transceiver.

5. The communication architecture according to claim 1, wherein said non-electrical signaling path comprises a fiber optic signaling path.

6. The communication architecture according to claim 5, wherein said RF transceiver is installed adjacent to the top of a tower, and wherein said digital communication signal processing unit is installed adjacent to the base of said tower, and said fiber optic signaling path extends along said tower between said top and base thereof, and wherein said communication signal processing unit and said RF transceiver are coupled to respective ends of said fiber optic signaling path through associated electro-optic and opto-electronic converter units.

7. The communication architecture according to claim 5, wherein said fiber optic signaling path includes first and second uplink fiber optic paths that are operative to transport quadrature modulation transmit channels from said digital communication signal processing unit to said RF transceiver for transmission, and first and second downlink fiber optic paths that are operative to transport quadrature modulation transmit channels from said RF transceiver to said digital communication signal processing unit.

8. The communication architecture according to claim 7, wherein a selected uplink fiber optic path is operative to transport an uplink control channel from said digital communication signal processing unit to said RF transceiver, and a selected downlink fiber optic path is operative to transport a downlink control channel from said RF transceiver to said digital communication signal processing unit.

9. The communication architecture according to claim 8, wherein said control channels are frequency shift keyed (FSK) modulation control channels.

10. A method of coupling communication signals between a digital communication signal processing unit adjacent to the base of a tower structure and a radio frequency (RF) transceiver mounted at an elevated position of said tower structure, said method comprising the steps of:
(a) coupling a non-electrical signaling path to said RF transceiver and said digital communication signal processing unit;
(b) transporting communication signals from said digital signal processing unit to said RF transceiver for transmission thereby; and
(c) transporting communication signals received by said RF transceiver to said digital communication signal processing unit.

11. The method according to claim 10, further comprising the step (d) of supplying power for operating said RF transceiver from a power source to said RF transceiver over an electrical link separate from said non-electrical signaling path coupling said RF transceiver with said digital communication signal processing unit.

12. The method according to claim 10, wherein said digital communication signal processing unit comprises a baseband processor that is operative to interface digital telecommunication signals transported over a terrestrial digital telecommunication link with said non-electrical signaling path.

13. The method according to claim 10, further comprising the step (d) of transporting a control channel over said non-electrical signaling path between said digital communication signal processing unit and said transceiver.

14. The method according to claim 10, wherein said non-electrical signaling path comprises a fiber optic signaling path, and wherein said digital communication signal processing unit and said RF transceiver are coupled to respective ends of said fiber optic signaling path through associated electro-optic and opto-electronic converter units.

15. The method according to claim 14, wherein said fiber optic signaling path includes first and second uplink fiber optic paths that are operative to transport quadrature modulation transmit channels from said digital communication signal processing unit to said RF transceiver for transmission, and first and second downlink fiber optic paths that are operative to transport quadrature modulation transmit channels from said RF transceiver to said digital communication signal processing unit.

16. The method according to claim 15, further comprising the step (d) of transporting an uplink control channel over a selected uplink fiber optic path from said digital communication signal processing unit to said RF transceiver, and transporting a downlink control channel over a selected downlink fiber optic path from said RF transceiver to said digital communication signal processing unit.

17. An arrangement for coupling communication signals between a digital communication signal processing unit adjacent to the base of a tower structure and a radio frequency (RF) transceiver mounted at an elevated position of said tower structure, said arrangement comprising
an uplink fiber optic signaling path coupled between said digital communication signal processing unit and said RF transceiver and being operative to transport communication signals from said digital signal processing unit to said RF transceiver for transmission thereby; and
a downlink fiber optic signaling path coupled between said RF transceiver and said digital communication signal processing unit, and being operative to transport communication signals received by said RF transceiver to said digital communication signal processing unit.

18. The arrangement according to claim 17, further comprising an electrical link separate from said fiber optic signaling paths that is configured to supply power for operating said RF transceiver from a power source to said RF transceiver.

19. The arrangement according to claim 18, wherein said digital communication signal processing unit comprises a baseband processor that is operative to interface digital telecommunication signals transported over a terrestrial digital telecommunication link with said non-electrical signaling path.

20. The arrangement according to claim 17, wherein said uplink and downlink fiber optic signaling paths are operative to transport a control channel between said digital communication signal processing unit and said RF transceiver.
